(19) United States
(12) Patent Application Publication
(10) Pub. No.: US 2002/0150119 A1
(43) Pub. Date: Oct. 17, 2002

(54) Method for transmitting data in real time and radio communication network therefor

(76) Inventors: Emmanuel Seurre, Aulnay Sur Mauldre (FR); Patrick Savelli, Rennes (FR)

Correspondence Address: Sughrue Mion Zinn, Macpeak & Seas, 2100 Pennsylvania Avenue NW, Washington, DC, 20037-3213, US

(21) Appl. No.: 10/089,226

(22) PCT Filed: Jul. 19, 2001
(86) PCT No.: PCT/FR01/02351

(30) Foreign Application Priority Data
Jul. 31, 2000 (FR) 0010043

(51) Int. Cl. H04J 3/16

(52) U.S. Cl. 370/442; 370/468

(57) ABSTRACT

The present invention relates to a method of transmitting data in packets in real time between a network and a mobile radiocommunication terminal over a plurality of multiframes each including a given number of blocks.

The method is characterized in that it dynamically allocates or attributes to the terminal or to each terminal concerned one or more dedicated uplink and/or downlink transmission signaling and/or control blocks independently of and separately from blocks allocated to the transfer of data.

The present invention relates to managing calls in cellular radiocommunication networks, in particular to managing downlink transmission to stations or mobile terminals of said networks and uplink transmission from said mobiles to said networks.

The present invention provides a method of transmitting data in packets in real time, to be more precise a method of transmitting data in real time with fixed allocation of control blocks, and a cellular radiocommunication network using the method.

In this document, the term “uplink” refers to a transmission or a transmission channel from one or more mobile terminals to the network and the term “downlink” refers to a transmission or a transmission channel from the network (or a base station thereof) to one or more mobiles affiliated to it.

At present, in the context of transmitting information in packets, for example in accordance with the General Packet Radio Service (GPRS) standard, the Enhanced General Packet Radio Service (EGPRS) standard, and the GSM/EDGE/Radio Access Network (GERAN) standard, nothing is done to ensure the conservation of a constant bit rate, which is necessary for real time transmission streams, between the mobile stations and the network when a message or signaling or control data must be transmitted in either transmission direction.

Accordingly, for the GERAN standard, signaling messages and Radio Link Control (RLC) user data blocks are multiplexed onto the same uplink and downlink transmission physical resource. An indicator PT in the Medium Access Control (MAC) header of each block received is read to determine whether it is a user data block or a signaling and/or control block.

This solution does not satisfy the essential condition for real time transmission, namely that there should be no variation in routing time-delays, since, in the event of induced time-delay variations, each signaling message sent on an uplink or downlink radio resource shared with user data blocks will interfere with real time transmission and degrade the quality of the communication link.

An object of the present invention is to alleviate the drawbacks previously cited and to propose a solution for transmitting signaling messages without interfering with real time transmission.

To this end, the present invention proposes a method of transmitting data in packets in real time between a network and a mobile radiocommunication terminal over a plurality of multiframes each including a given number of blocks, which method is characterized in that it dynamically allocates or attributes to the terminal or to each terminal concerned one or more dedicated uplink and/or downlink transmission signaling and/or control blocks independently of and separately from blocks allocated to the transfer of data.

A preferred embodiment of the invention can employ a fixed allocation of blocks to a multiframe or a set of multiframes for transmitting signaling and/or control messages for the entire duration of a call (consisting of several bidirectional transmissions between the terminal and the network) or a given transmission sequence (constituting part of a call).

Instead of, or in addition to the arrangements previously cited, the network can reattribute the dedicated block or blocks allocated to signaling and/or control during a call or during a given transmission sequence of a call.

In a first variant of the invention the attribution of control blocks associated with packet transmission consists of allocating one uplink and/or downlink transmission block per multiframe, identified by its number in said multiframe, on the same time slot as or a different time slot from the traffic channel.

In a second variant of the invention one or more control blocks associated with packet transmission is or are attributed by indicating a multiframe number and one or more uplink and/or downlink transmission block numbers in said multiframe in the same time slot as or a different time slot from the traffic channel.

If the control channel is shared between mobile terminals, an indicator or an identification field is provided in the control block for identifying the mobile station sending or receiving multiplexed uplink and/or downlink transmission signaling blocks on said channel.

However, downlink transmission control blocks transmitted from the network to a given mobile terminal can instead incorporate an identifier for identifying the destination mobile terminal of the block containing said signaling or control message.

The method previously cited is described in more detail below, by way of non-limiting example, in relation to a transmission method based on the GERAN standard.

In the present application, the solution proposed by the invention consists of using a fixed allocation of the control channel (PACCH) associated with uplink and downlink traffic packet transmission in a multiframe 52 or in a set of multiframes 52, by indicating a block number or a block number and a multiframe number, on the same time slot as or a different time slot from said traffic channel.

Thus control blocks and RLC data blocks are not multiplexed onto the same physical downlink or uplink transmission resource.

For downlink transmission, the Downlink Fixed Packet Associated Control Channel (DL FPACCH) is shared between a plurality of mobile terminals and the identification of the destination mobile terminal is given by a Temporary Flow Identifier (TFI) in the RLC/MAC control block or an identifier in the signaling message.

For uplink transmission, the Uplink Fixed Packet Associated Control Channel (UL FPACCH) is shared between a plurality of mobile terminals and the identification of the source mobile terminal is given by a TFI in the RLC data block.

Note that implementing the method according to the invention in an existing network is relatively easy and requires only minor modifications.

The invention also provides a cellular radio telecommunication network including geographically distributed fixed stations and mobile terminals that can communicate with each other for uplink transmission from the mobiles to the network and/or downlink transmission from the network to the mobiles, said [sic] data being transmitted in real time in packets over multiframes each formed of a given number of blocks and each of which can be shared between mobile terminals.

Said network is characterized in that each terminal is allocated or attributed one or more dedicated uplink and/or downlink transmission signaling and/or control blocks, independently of and separately from blocks allocated to the transfer of data.

Dedicated signaling and/or control blocks are preferably allocated or attributed in the manner previously described.

Finally, the invention also provides a cellular mobile radiocommunication terminal, optionally forming part of a network of the type defined above, characterized in that it is adapted to implement the real time data transmission method as described above.

Of course, the invention is not limited to the embodiments described, which can be modified without departing from the scope of protection of the invention, in particular from the point of view of the composition of the component parts or by substituting technical equivalents.

1.. A method of transmitting data in packets in real time between a network and a mobile radiocommunication terminal over a plurality of multiframes each including a given number of blocks, which method is characterized in that it dynamically allocates or attributes to the terminal or to each terminal concerned one or more dedicated uplink and/or downlink transmission signaling and/or control blocks independently of and separately from blocks allocated to the transfer of data.

2. A method according to claim 1, characterized in that it employs a fixed allocation of blocks to a multiframe or a set of multiframes for transmitting signaling and/or control messages for the entire duration of a call or a given transmission sequence.

3. A method according to either claim 1 or claim 2, characterized in that the network reattributes the dedicated block or blocks allocated to signaling and/or control during a call or during a given transmission sequence of a call.

4. A method according to any of claims 1 to 3, characterized in that the attribution of control blocks associated with packet transmission consists of allocating one uplink and/or downlink transmission block per multiframe, identified by its number in said multiframe, on the same time slot as or a different time slot from the traffic channel.

5. A method according to any of claims 1 to 3, characterized in that one or more control blocks associated with packet transmission is or are attributed by indicating a multiframe number and one or more uplink and/or downlink transmission block numbers in said multiframe in the same time slot as or a different time slot from the traffic channel.

6. A method according to any of claims 2 to 5, characterized in that, if the control channel is shared between mobile terminals, an indicator or an identification field is provided in the control block for identifying the mobile station sending or receiving multiplexed uplink and/or downlink transmission signaling blocks on said channel.

7. A method according to any of claims 2 to 5, characterized in that, if the control channel is shared between mobile stations, downlink transmission control blocks transmitted from the network to a given mobile terminal incorporate an identifier for identifying the destination mobile terminal of the block containing said signaling or control message.

8. A method according to any of claims 1 to 7, characterized in that transmission is to the GERAN standard.

9. A cellular radio telecommunication network including geographically distributed fixed stations and mobile terminals that can communicate with each other for uplink transmission from the mobiles to the network and/or downlink transmission from the network to the mobiles, said [sic] data being transmitted in real time in packets over multiframes each formed of a given number of blocks and each of which can be shared between mobile terminals, which network is characterized in that each terminal is allocated or attributed one or more dedicated uplink and/or downlink transmission signaling and/or control blocks, independently of and separately from blocks allocated to the transfer of data.

10. A network according to claim 9, characterized in that dedicated signaling and/or control blocks are allocated or attributed in accordance with any of claims 2 to 8.

11. A cellular mobile radiocommunication terminal, optionally forming part of a network according to either claim 9 or claim 10, characterized in that it is adapted to implement the real time data transmission method according to any of claims 1 to 8.
